(19) United States
(12) Patent Application Publication
(10) Pub. No.: US 2025/0091663 A1
(43) Pub. Date: Mar. 20, 2025

(54) CONNECTION STRUCTURE OF VEHICLE BODY

(71) Applicants: Hyundai Motor Company, Seoul (KR); Kia Corporation, Seoul (KR)

(72) Inventors: Won Ki Song, Hwaseong-si (KR); Jaeseung Lee, Hwaseong-si (KR); Hyungsik Choi, Hwaseong-si (KR); Dae Hee Lee, Hwaseong-si (KR); Jin Ho Hwang, Hwaseong-si (KR); Joonghyun Shin, Hwaseong-si (KR); Sun Hyung Cho, Hwaseong-si (KR)

(21) Appl. No.: 18/819,355

(22) Filed: Aug. 29, 2024

(30) Foreign Application Priority Data
Sep. 20, 2023 (KR) 10-2023-0125387

(51) Int. Cl. B62D 27/06; B62D 21/03; B62D 24/00; B62D 25/20; B62D 63/02

(52) U.S. Cl. CPC B62D 27/065; B62D 21/03; B62D 24/00; B62D 25/20; B62D 63/025

(57) ABSTRACT

A connection structure of a vehicle body can include an under body with an under body mounting unit mounted thereon, and a variable part including a variable part mounting unit selectively connected to the under body mounting unit and an outer cross member mounted on an upper portion of the variable part mounting unit.

### CROSS-REFERENCE TO RELATED APPLICATIONS

This application claims priority to and the benefit of Korean Patent Application No. 10-2023-0125387 filed in the Korean Intellectual Property Office on Sep. 20, 2023, the entire contents of which are incorporated herein by reference.

### TECHNICAL FIELD

The present disclosure relates to a connection structure of a vehicle body.

### BACKGROUND

Recently, the vehicle industry is introducing a new concept of future mobility vision for realizing a human-centered, dynamic future city. One of these future mobility solutions is a Purpose Built Vehicle (PBV) as purpose-based mobility.

A PBV can be an example of an electric vehicle (EV)-based environment-friendly mobile vehicle. This PBV can provide various customized services to users while moving from the starting point to the destination in an unmanned autonomous driving method.

The vehicle body of such a PBV is composed of an under body (also referred to as a rolling chassis or a skateboard in the art) and an upper body assembled to the under body.

Here, the upper body may be configured in various forms according to the type of customized service of PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front part of the upper body and a luggage room is configured in the rear part.

PBV can only be used as a hailing or delivery vehicle, but if the user can use it while changing its purpose, the vehicle's usage time can be significantly increased.

In other words, if the use of the vehicle can be easily changed, and the cabin at the front of the vehicle, including the driver's seat of the upper body, and the underbody are of a common configuration, and the rear of the upper body is configured to be easily replaced, the cost can be reduced while improving vehicle utilization.

Matters described in this background art section are prepared to enhance understanding of the background of the present disclosure, and may include matters other than conventional art already publicly known, available, or in use.

### SUMMARY

The present disclosure relates to a vehicle body. More particularly, the present disclosure relates to a connection structure of a vehicle body.

An embodiment of the present disclosure can provide a connection structure of a vehicle body that can be easily changed to various types of vehicle bodies to increase the utilization of PBV.

A connection structure of a vehicle body according to an example embodiment may include an under body with an under body mounting unit mounted thereon, and a variable part including a variable part mounting unit selectively connected to the under body mounting unit and an outer cross member mounted on an upper portion of the variable part mounting unit.

An under body insert hole may be formed in the upper part of the under body, and the under body mounting unit may be inserted into the under body insert hole.

The under body mounting unit and the under body may be bolted together in the height direction of the vehicle body and the length direction of the vehicle body.

An under body connection recess portion may be formed on at least one side of the under body, and the under body connection recess portion may support the under body mounting unit.

The variable part may include a rear floor, the variable part mounting unit may be connected to the rear floor, and the outer cross member may be connected to the upper part of the rear floor.

The outer cross member and the rear floor may form a cross member closed space along the length direction of the vehicle body.

The connection structure according to an example embodiment may further include a connection support mounted between the rear floor and the outer cross member.

A connection support hole may be formed in the connection support, and the variable part mounting unit may be engaged with the connection support hole through the variable part mounting bolt.

The connection structure according to an example embodiment may further include a spacer disposed between the connection support and the rear floor, into which the variable part mounting bolt is inserted.

The connection structure according to an example embodiment may further include a plurality of floor cross members that are connected to the lower part of the rear floor in the width direction of the vehicle body and disposed spaced apart along the length direction of the vehicle body.

The plurality of floor cross members may include a central cross member, a front cross member disposed at the front of the central cross member, and a rear cross member disposed at the rear of the central cross member.

The connection structure according to an example embodiment may further include a plurality of seat cross members that are connected to the upper part of the rear floor in the length direction of the vehicle body and disposed spaced apart along the width direction of the vehicle body.

The plurality of seat cross members may include the outer cross member disposed on both sides of the width direction of the vehicle body, and an inner cross member disposed between the outer cross members.

The plurality of seat cross members may overlap in the vertical direction with at least two of the plurality of floor cross members.

The connection structure according to an example embodiment may further include a seat frame connected to an upper part of the seat cross member to support a seat.

According to an example embodiment, it is possible to provide a solid mounting structure of a mounting unit connecting the under body and the variable part.

According to example embodiments of the present disclosure, the variable part can be easily changed to various types of vehicle body to increase the utilization of PBV.

According to the connection structure of a vehicle body according to an example embodiment, it is easy to disperse the collision load during vehicle collision by various configuration for fixing the seat and the load path of the under body.

In addition, the advantages that can be obtained or expected from an embodiment of the present disclosure can be disclosed directly or implicitly in a detailed description of the present disclosure. In other words, various advantages predicted according to the present disclosure can be disclosed within the detailed description to be described later.

### BRIEF DESCRIPTION OF THE DRAWINGS

Because these drawings are intended for reference in explaining the example embodiments of the present disclosure, technical ideas of the present disclosure are not necessarily limited to the accompanying drawings.

FIG. 1 is an exploded perspective view showing a connection structure of a vehicle body according to an example embodiment of the present disclosure.

FIG. 2 is a partial perspective view of the connection structure of a vehicle body according to an example embodiment of the present disclosure.

FIG. 3 is an enlarged drawing showing a part of FIG. 2.

FIG. 4 is an exploded perspective view of an underbody mounting unit and an underbody of the connection structure of a vehicle body according to an example embodiment of the present disclosure.

FIG. 5 is a perspective view of the underbody mounting unit and the underbody of the connection structure of a vehicle body according to an example embodiment of the present disclosure.

FIG. 6 is an exploded perspective view of a variable part mounting unit and an outer cross member of the connection structure of a vehicle body according to an example embodiment of the present disclosure.

FIG. 7 is a cross-sectional view along line A-A in FIG. 3.

FIG. 8 is a cross-sectional view along line B-B in FIG. 3.

FIG. 9 is a cross-sectional view along line C-C in FIG. 3.

FIG. 10 is a top plan view of the connection structure of a vehicle body according to an example embodiment of the present disclosure.

FIG. 11 is a drawing showing load paths of the connection structure of a vehicle body according to an example embodiment of the present disclosure.

FIG. 12 is a top plan view of the connection structure of a vehicle body according to an example modified embodiment of the present disclosure.

The drawings referenced above are not necessarily drawn to scale and can be understood as presenting a rather simplified representation of various features illustrating the principles and example embodiments of the disclosure. The specific design features of an embodiment of the present disclosure, including, for example, specific dimensions, orientation, location, and shape, can be determined in part by the particular intended application and usage environment.

### DETAILED DESCRIPTION OF ILLUSTRATIVE EMBODIMENTS

Hereinafter, with reference to the attached drawings, example embodiments of the present disclosure will be described in detail so that those skilled in the art can easily implement the present disclosure. As those skilled in the art can realize, the described example embodiments may be modified in various different ways, all without departing from the spirit or scopes of the present disclosure.

The terminology used herein can be for the purpose of describing specific embodiments and is not intended to necessarily limit the present disclosure. As used herein, singular forms can be intended to also include plural forms, unless the context clearly indicates otherwise.

The terms “comprise” and/or “comprising” as used herein indicate the presence of specified features, integers, steps, operations, elements, and/or components, but it does not exclude the presence or addition of one or more other features, integers, steps, operations, components, and/or groups thereof.

As used in this specification, the term “and/or” can include any one or all combinations of at least one of the associated listed items.

In this specification, the term “connected” or “coupled” can indicate a physical relationship between two components, for example, a physical relationship in which components are directly connected to each other by welding, self piercing rivet (SPR), flow drill screw (FDS), structural adhesive, or the like, or can indicate components that are indirectly connected through one or more intermediate components.

As used herein, “vehicle”, “vehicular”, “automotive” or other similar terms as used herein can generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs (purpose built vehicles), hydrogen-powered vehicles, and other alternative fuel vehicles (e.g., other than petroleum fuel derived from resources), for example.

Hereinafter, example embodiments of the present disclosure will be described in detail with reference to the accompanying drawings.

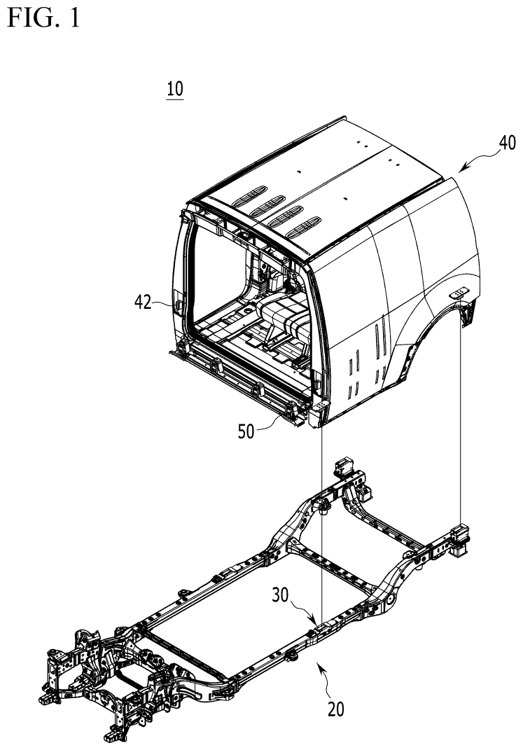

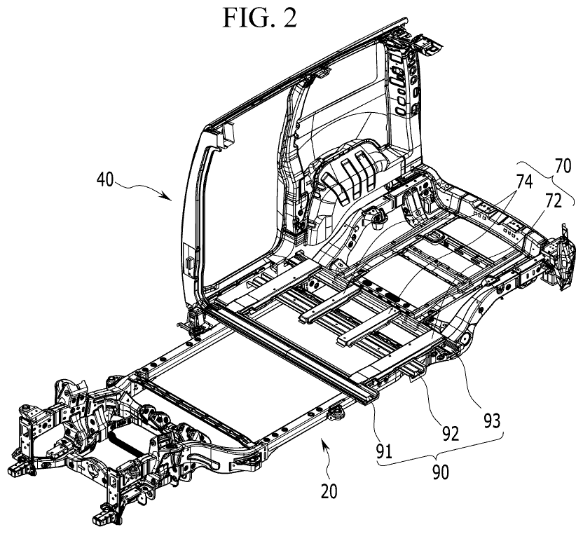

FIG. 1 is an exploded perspective view showing a connection structure of a vehicle body according to an example embodiment. FIG. 2 is a partial perspective view of the connection structure of a vehicle body according to an example embodiment.

Referring to FIG. 1 and FIG. 2, according to an example embodiment, the vehicle body 10 to which the following connection structure of a vehicle body can be applied may be, for example, a purpose-based mobility vehicle (Purpose Built Vehicle: hereinafter referred to as “PBV”).

The PBV can be used as an electric vehicle-based life module vehicle that provides various customized services to users during the travel time from the origin to the destination.

In one example, the PBV can be manufactured in a one box type design with a large interior space. Furthermore, the PBV may have facing-type seats applied to the indoor space.

This PBV vehicle body can be suitable for small quantity production of various vehicle types with a small number of parts, and can be manufactured in various shapes and sizes.

The vehicle body of the PBV can include a skateboard-type under body 20 (commonly referred to as a “rolling chassis” or “chassis frame” by those skilled in the art) and an upper body assembled to the under body 20.

The under body 20 may be equipped with components such as a battery assembly and a drive motor. Additionally, the upper body can be a BIW (Body In White) combined with the under body 20, and may include a cabin with a large interior space and a luggage room.

In this specification, the “front to rear direction of the vehicle body” can be the longitudinal direction of the vehicle body, the “vehicle width direction” can be the left-right direction of the vehicle body, and the “up-and-down direction” can be the height direction of the vehicle body.

In this specification, “upper end”, “upper portion”, or “upper surface” of a component can indicate an end, portion, or surface of a component that is relatively upper in the drawing, and “lower end”, “lower portion”, or “lower surface” of a component can indicate an end, portion, or surface of a component that is relatively lower in the drawing.

Furthermore, in this specification, an end of a component (e.g., one end or another (other) end, etc.) can denote an end of a component in any one direction, and an end portion of the component (e.g., one end portion) or other (another) end portion, etc.) can denote a portion of a component that includes that end.

According to an example embodiment, the connection structure of a vehicle body may be a structure in which an upper body of various shapes and purposes can be applied to the under body 20 depending on the type of PBV's customized service.

For this purpose, the connection structure of a vehicle body according to an example embodiment can include a front body module (not shown) and a rear body module 40 as an upper body.

A front mounting unit 42 may be mounted on the front of the rear body module 40 to be connected with a front body module (not shown). The front body module, for example, may be a fixed part fixed to the under body 20. The fixed part can be a component coupled to the under body 20, and can be a component that is not replaced even if the purpose of use of the vehicle is changed.

The rear body module 40 can be a component that can be replaced depending on the purpose of use of the vehicle, and can be a variable part 40 (replaceable portion).

Each “mounting unit” can be a configuration for combining the front body module and/or rear body module of the upper body and the under body. For example, the “mounting unit” can be a mechanical configuration that can be coupled manually, assembled through the operation of a separate actuator, including magnetics and can be coupled and/or released depending on the supply of external or internal power for various types of combinations. A detailed explanation of the configuration and operation of the “mounting unit”, which can connect or disconnect one or more modules or frames can be omitted.

An under body mounting unit 30 can be mounted on the under body 20.

A variable part mounting unit 50, which can be selectively connected to the under body mounting unit 30, can be mounted on the fixed part.

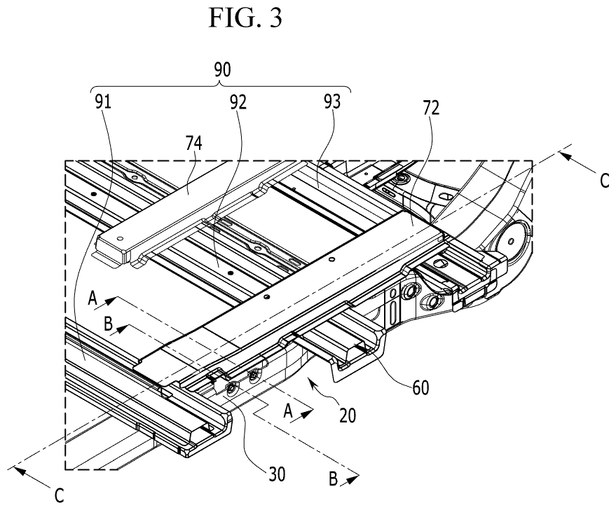

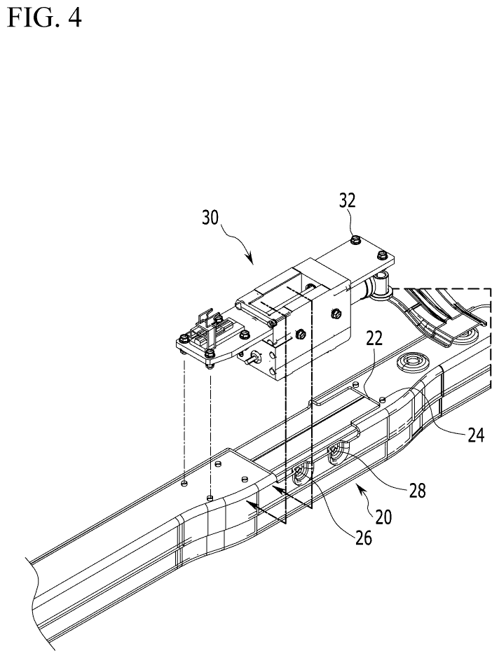

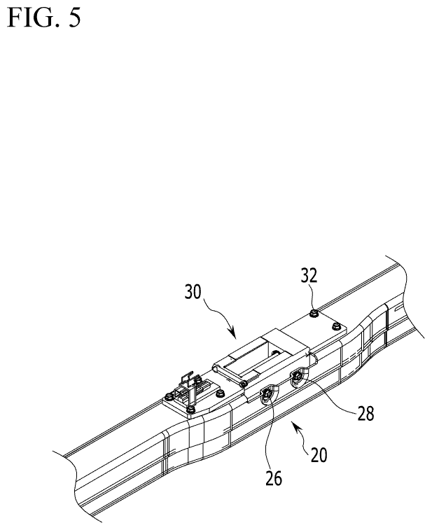

FIG. 3 is an enlarged drawing showing a part of FIG. 2. FIG. 4 is an exploded perspective view of an underbody mounting unit and an underbody of the connection structure of a vehicle body according to an example embodiment. FIG. 5 is a perspective view of the underbody mounting unit and the underbody of the connection structure of a vehicle body according to an example embodiment.

Referring to FIG. 1 to FIG. 5, an under body insert hole 22 can be formed in the upper part of the under body 20, and the under body mounting unit 30 may be inserted into the under body insert hole 22.

The under body mounting unit 30 can be inserted into the under body insert hole 22 to minimize the exposure or protrusion of the under body mounting unit 30.

The under body mounting unit 30 and the under body 20 may be connected by bolting.

For example, in the upper part of the under body 20, an under body upper connection hole 24 can be formed around the under body insert hole 22. And an under body mounting bolt 32 can be engaged in the under body upper connection hole 24 so that the under body mounting unit 30 can be mounted on the under body 20.

Additionally, an under body side connection bolt 28 can be engaged on the side of the under body 20 to secure the under body mounting unit 30 to the under body 20. An under body connection recess portion 26 can be formed on the side of the under body 20 to prevent the under body side connection bolt 28 from protruding, can support the under body mounting unit 30, and can increase the strength of the under body 20.

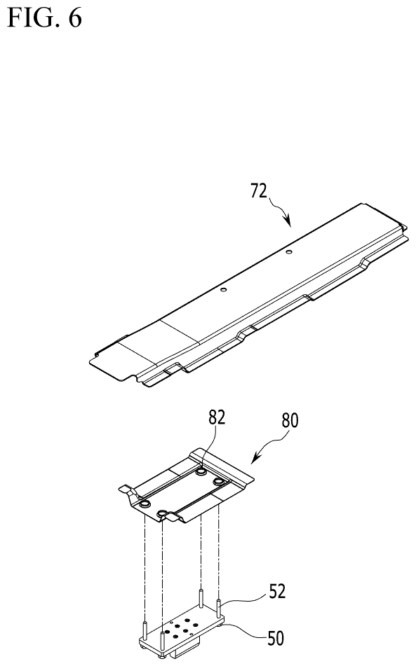

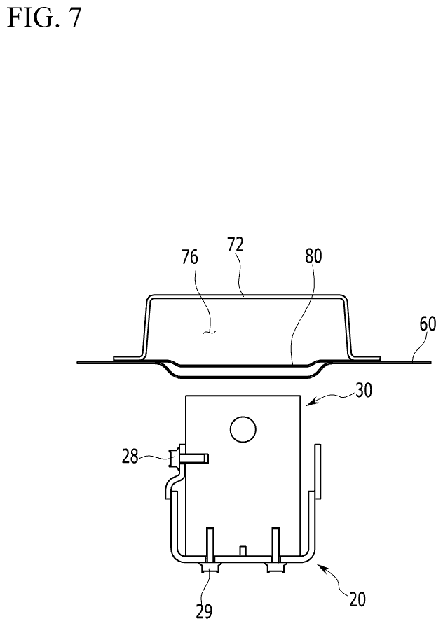

FIG. 6 is an exploded perspective view of a variable part mounting unit and an outer cross member of the connection structure of a vehicle body according to an example embodiment. FIG. 7 is a cross-sectional view along line A-A in FIG. 3.

The under body lower connection bolt 29 (see FIG. 7) may connect the lower part of the under body 20 and the under body mounting unit 30. Accordingly, the under body 20 and the under body mounting unit 30 can be connected in various directions, making the connection more robust, and also compensating for weakening strength caused by the under body insert hole 22.

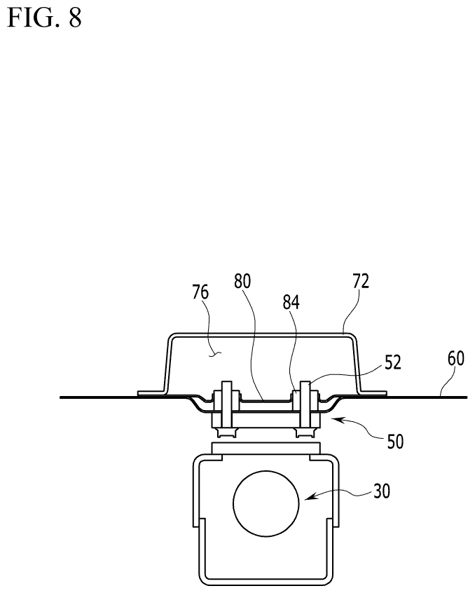

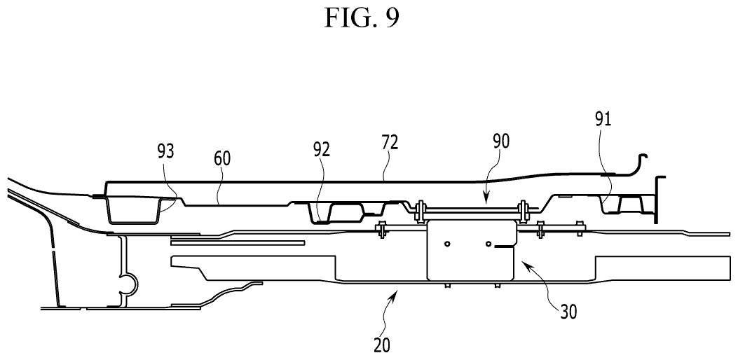

FIG. 8 is a cross-sectional view along line B-B in FIG. 3. FIG. 9 is a cross-sectional view along line C-C in FIG. 3.

Referring to FIG. 1 to FIG. 9, according to an example embodiment, the connection structure of a vehicle body can include the under body 20 on which the under body mounting unit 30 can be mounted, and the variable part 40. And the variable part 40 can include a variable part mounting unit 50 mounted to be selectively connected to the under body mounting unit 30, and an outer cross member 72 can be mounted on the upper part of the variable part mounting unit 50.

The outer cross member 72 can be disposed on the upper part of the variable part mounting unit 50 to disperse the load transmitted from the variable part mounting unit 50 or the load transmitted to the variable part mounting unit 50 and support the variable part mounting unit 50.

The variable part 40 can include a rear floor 60, and the variable part mounting unit 50 can be connected to the rear floor 60. For example, it may be connected by welding. Additionally, the outer cross member 72 can be connected to the upper part of the rear floor 60 and may support the rear floor 60 connected to the variable part mounting unit 50.

The outer cross member 72 and the rear floor 60 may form a cross member closed space 76 along the length direction of the vehicle body. The cross-section coefficient can increase due to the connected shape of the outer cross member 72 and the rear floor 60, and strength the lower part of the vehicle body 10 may be increased.

According to an example embodiment, the connection structure of a vehicle body may further include a connection support 80 mounted between the rear floor 60 and the outer cross member 72.

A connection support hole 82 can be formed in the connection support 80, and the variable part mounting unit 50 may be engaged with the connection support hole 82 through a variable part mounting bolt 52.

The variable part mounting unit 50 can be dually connected to the rear floor 60 and the connection support 80 through the variable part mounting bolt 52 to further secure the connection strength of the variable part mounting unit 50. Accordingly, it is possible to increase the rigid mount of the variable part mounting unit 50 and the strength around the mounting position of the variable part mounting unit 50.

According to an example embodiment, the connection structure of a vehicle body may further include a spacer 84 disposed between the connection support 80 and the rear floor 60 and into which the variable part mounting bolt 52 is inserted. The spacer 84 can separate the rear floor 60 and the connection support 80 at a certain distance, and support the variable part mounting bolt 52 to enable a firm connection of the variable part mounting unit 50.

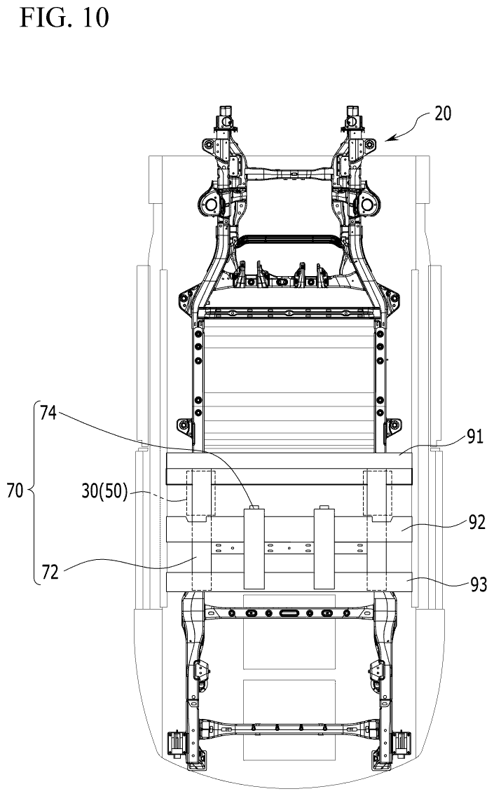

FIG. 10 is a top plan view of the connection structure of a vehicle body according to an example embodiment.

Referring to FIG. 1 to FIG. 10, according to an example embodiment, the connection structure of a vehicle body may further include a plurality of floor cross members 90 connected to the lower part of the rear floor 60 in the width direction of the vehicle body 10 and disposed spaced apart along the length direction of the vehicle body 10.

The plurality of floor cross members 90 may include a central cross member 92, a front cross member 91 disposed on the front of the central cross member 92, and a rear cross member 93 disposed on the rear of the central cross member 92.

The plurality of floor cross members 90 may be connected to the rear floor 60 along the width direction of the vehicle body 10, for example by welding, to increase the width direction strength of the vehicle body 10.

The front cross member 91 and the central cross member 92 can be disposed on the front and rear of the mounting positions of the under body mounting unit 30 and the variable part mounting unit 50 to transmit the load of the under body mounting unit 30 and the variable part mounting unit 50.

According to an example embodiment, the connection structure of a vehicle body may further include a plurality of seat cross members 70 connected to the upper part of the rear floor 60 in the length direction of the vehicle body 10 and disposed spaced apart along the width direction of the vehicle body 10.

The plurality of seat cross members 70 may include the outer cross member 72 disposed on both sides of the width direction of the vehicle body 10, and the inner cross member 74 disposed between the outer cross members 72. The outer cross member 72 can be disposed on the upper part of the variable part mounting unit 50 to disperse transferred load of the outer cross member 72.

In the drawing, two inner cross members 74 are shown, but an embodiment is not necessarily limited to this, and various shapes and numbers may be installed depending on the number and configuration of the sheets mounted on the variable part 40.

The plurality of seat cross members 70 may overlap with at least two of the plurality of floor cross members 90 in the vertical direction.

In FIG. 10, the central cross member 92, the rear cross member 93, and the seat cross member 70 are shown overlapped, but are not necessarily limited to this and may overlap with the front cross member 91.

The plurality of seat cross members 70 and the plurality of floor cross members 90 can overlap to ensure smooth load transfer and a solid connection between the seat cross member 70 and the floor cross member 90.

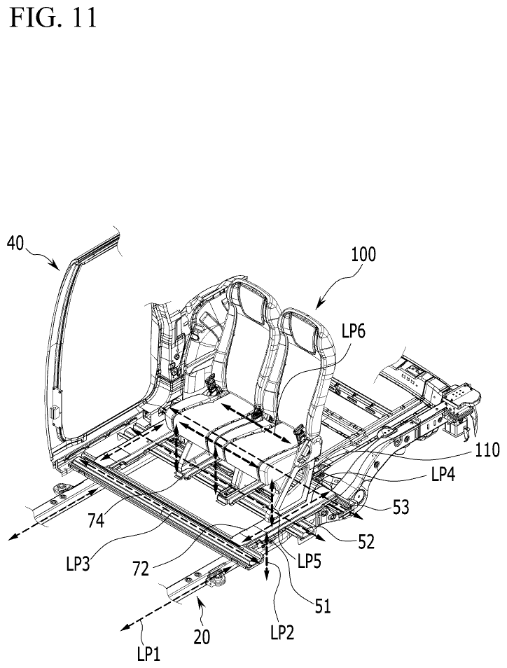

FIG. 11 is a drawing showing load paths of the connection structure of a vehicle body according to an example embodiment.

Referring to FIG. 11, a seat frame 110 supporting a seat 100 may be connected to the upper part of the seat cross member 70. The seat frame 110 can be connected to the seat cross member 70 to disperse the load of the seat 100 to the vehicle body 10 and the load transmitted from the variable part mounting unit 50.

According to an example embodiment, the connection structure of a vehicle body may form an under body longitudinal direction load path LP1 along the length direction of the vehicle body 10 of the under body 20, an under body height direction load path LP2 along to the vertical direction of the under body mounting unit 30 and the variable part mounting unit 50, a floor cross member load path LP3 along the floor cross member 90 in the width direction of the vehicle body 10, a seat cross member load path LP4 along the seat cross member 70 in the longitudinal direction of the vehicle body 10, a seat frame height direction load path LP5, and a seat frame lateral direction load path LP6 along the seat frame 110. Various load paths can be formed so that the load may be dispersed smoothly and vehicle body strength may be secured.

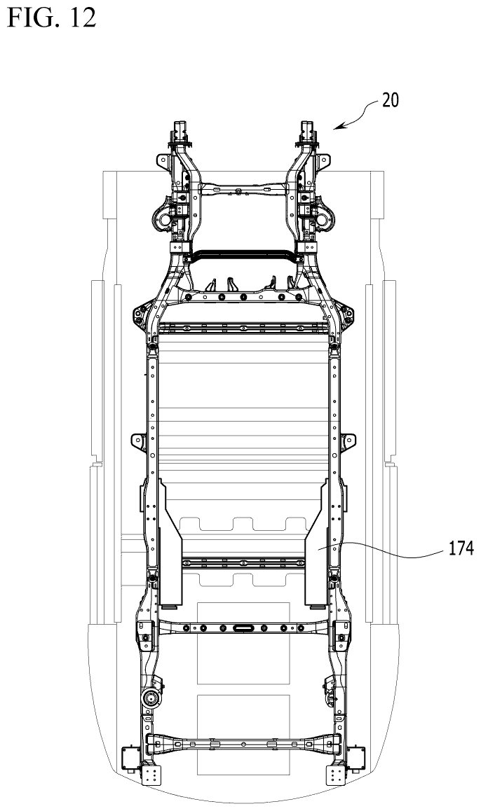

FIG. 12 is a top plan view of the connection structure of a vehicle body according to a modified example embodiment of the present disclosure.

If the width direction length of the under body 20 and the length of the seat do not match, part of the shape of the outer cross member 174 may be bent to the width direction of the vehicle body 10 to maintain top and bottom overlap with the variable part mounting unit 50.

The drawing shows that part of the shape of the outer cross member 174 can be bent inward in the width direction of the vehicle body 10, but an embodiment is not necessarily limited to this, and a shape bent outward is also possible.

As previously reviewed, according to the connection structure of a vehicle body according to an example embodiment, appropriate dispersion of the load is possible by reinforcing the configuration that selectively connects the variable part and the under body.

While example embodiments of this disclosure have been described in connection with what is presently considered to be practical example embodiments, it can be understood that the disclosure is not necessarily limited to the disclosed embodiments. On the contrary, the present disclosure can cover various modifications and equivalent arrangements included within the spirit and scopes of the appended claims.

What is claimed is:

1. A connection structure of a vehicle body comprising:
an under body with an under body mounting unit mounted thereon; and
a variable part including a variable part mounting unit selectively connected to the under body mounting unit and an outer cross member mounted on an upper portion of the variable part mounting unit.

2. The structure of claim 1, wherein an under body insert hole is in an upper part of the under body, and wherein the under body mounting unit is inserted into the under body insert hole.

3. The structure of claim 2, wherein the under body mounting unit and the under body are bolted together in a height direction of the vehicle body and a length direction of the vehicle body.

4. The structure of claim 3, wherein an under body connection recess portion is on at least one side of the under body, and wherein the under body connection recess portion supports the under body mounting unit.

5. The structure of claim 1, wherein the variable part comprises a rear floor, wherein the variable part mounting unit coupled to the rear floor, and wherein the outer cross member is coupled to an upper part of the rear floor.

6. The structure of claim 5, wherein the outer cross member and the rear floor form a cross member closed space along a length direction of the vehicle body.

7. The structure of claim 5, further comprising a connection support mounted between the rear floor and the outer cross member.

8. The structure of claim 7, wherein a connection support hole is in the connection support, and wherein the variable part mounting unit is engaged with the connection support hole through a variable part mounting bolt.

9. The structure of claim 8, further comprising a spacer disposed between the connection support and the rear floor, into which the variable part mounting bolt is inserted.

10. The structure of claim 5, further comprising a plurality of floor cross members that are connected to a lower part of the rear floor in a width direction of the vehicle body and disposed spaced apart along a length direction of the vehicle body.

11. The structure of claim 10, wherein the plurality of floor cross members comprises:
a central cross member;
a front cross member disposed at a front of the central cross member; and
a rear cross member disposed at a rear of the central cross member.

12. The structure of claim 11, further comprising a plurality of seat cross members connected to the upper part of the rear floor in the length direction of the vehicle body and disposed spaced apart along the width direction of the vehicle body.

13. The structure of claim 12, wherein the plurality of seat cross members comprises:
the outer cross member disposed on both sides of the width direction of the vehicle body; and
an inner cross member disposed between the outer cross members.

14. The structure of claim 12, wherein the plurality of seat cross members overlaps in a vertical direction with at least two of the plurality of floor cross members.

15. The structure of claim 12, further comprising a seat frame connected to an upper part of the seat cross members to support a seat.

16. A vehicle body comprising:
an under body;
a variable part; and
means for selectively connecting the variable part to the under body.

17. The vehicle body of claim 16, wherein the under body comprises means for increasing strength of the vehicle body.

18. The vehicle body of claim 16, wherein the variable part comprises means for increasing strength of the vehicle body.

19. A vehicle body comprising:
an under body with an under body mounting unit mounted thereon, wherein an under body insert hole is in an upper part of the under body, wherein the under body mounting unit is inserted into the under body insert hole, wherein the under body mounting unit and the under body are bolted together in a height direction of the vehicle body and a length direction of the vehicle body, wherein an under body connection recess portion is on at least one side of the under body, and wherein the under body connection recess portion supports the under body mounting unit;
a variable part including a variable part mounting unit selectively connected to the under body mounting unit and an outer cross member mounted on an upper portion of the variable part mounting unit, wherein the variable part comprises a rear floor, wherein the variable part mounting unit coupled to the rear floor, and wherein the outer cross member is coupled to the upper part of the rear floor, wherein the outer cross member and the rear floor form a cross member closed space along a length direction of the vehicle body;
a connection support mounted between the rear floor and the outer cross member, wherein a connection support hole is in the connection support, and wherein the variable part mounting unit is engaged with the connection support hole through a variable part mounting bolt; and
a spacer disposed between the connection support and the rear floor, into which the variable part mounting bolt is inserted.

20. The vehicle body of claim 19, further comprising:
a plurality of floor cross members that are connected to a lower part of the rear floor in a width direction of the vehicle body and disposed spaced apart along a length direction of the vehicle body, wherein the plurality of floor cross members includes:
a central cross member,
a front cross member disposed at a front of the central cross member, and
a rear cross member disposed at a rear of the central cross member;
a plurality of seat cross members connected to the upper part of the rear floor in the length direction of the vehicle body and disposed spaced apart along the width direction of the vehicle body, wherein the plurality of seat cross members includes:
the outer cross member disposed on both sides of the width direction of the vehicle body, and
an inner cross member disposed between the outer cross members, wherein the plurality of seat cross members overlaps in a vertical direction with at least two of the plurality of floor cross members; and
a seat frame connected to an upper part of the seat cross member to support a seat.
